(19) United States
(12) Patent Application Publication
(10) Pub. No.: US 2026/0023577 A1
(43) Pub. Date: Jan. 22, 2026

(54) METHODS FOR ADJUSTING PLATFORM CAPABILITY FOR OPTIMIZING PERFORMANCE, DEVICES AND COMPUTER-READABLE MEDIUM THEREOF

(71) Applicant: MEDIATEK INC., Hsinchu City (TW)

(72) Inventors: Yen-Ting PAN, Hsinchu City (TW); Hsien-Hsi HSIEH, Hsinchu City (TW); Cheng-Che CHEN, Hsinchu City (TW)

(21) Appl. No.: 19/266,315

(22) Filed: Jul. 11, 2025

Related U.S. Application Data
(60) Provisional application No. 63/672,788, filed on Jul. 18, 2024.

(51) Int. Cl. G06F 9/445; G06F 9/48

(52) U.S. Cl. CPC G06F 9/44505; G06F 9/4893

(57) ABSTRACT

A method for adjusting platform capability for optimizing performance is provided. The method is implemented by a processor of a device. The method includes receiving a hint signal from an application, wherein the hint signal indicates a requirement required by the application. The method includes obtaining a set of operating parameters of one or more computing components related to the application. The method includes adjusting one or more operating parameters of the set of operating parameters according to the hint signal and the set of operating parameters to meet the requirement required by the application.

### CROSS REFERENCE TO RELATED APPLICATIONS

This application claims the benefit of U.S. Provisional Application No. 63/672,788, entitled “Provisional-dynamic adjust freq. for optimizing performance while minimizing power consumption based on bottleneck identification”, filed on Jul. 18, 2024, the entirety of which is incorporated by reference herein.

### BACKGROUND OF THE INVENTION

### Field of the Invention

The present disclosure generally relates to the field of platform capability management. More specifically, aspects of the present disclosure relate to methods for adjusting platform capability for optimizing performance, devices and computer-readable medium thereof.

### Description of the Related Art

What we are pursuing now on mobile platforms are new ways to consume the least resources and obtain a sustained, stable performance. However, due to the layered separation between platforms and applications with existing technologies, most platforms can only estimate the future resources required for applications based on past history, and applications can only make adjustments based on platform information, which may be limited.

Even though there is a concept to integrate information between applications and the platform, there still exists a barrier in application developers' understanding of the platform's capabilities.

Therefore, there is a need for methods for adjusting platform capability for optimizing performance, devices and the computer-readable medium thereof to solve this problem.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, one of the main purposes of the present disclosure is to provide methods for adjusting platform capability for optimizing performance, devices and computer-readable medium thereof.

In an exemplary embodiment, a method for adjusting platform capability for optimizing performance is provided. The method is implemented by a device. The method includes receiving a hint signal from an application, wherein the hint signal indicates a requirement required by the application. The method includes obtaining a set of operating parameters of one or more computing components related to the application. The method includes adjusting one or more operating parameters of the set of operating parameters according to the hint signal and the set of operating parameters to meet the requirement required by the application.

In some embodiments, the set of operating parameters comprises at least one of the following: a workload level, an amount of computation, a power state, an amount of network transmission traffic, a frame rate of a display of the device and a thermal state.

In some embodiments, the one or more computing components at least comprises a central processing unit (CPU), a graphics processing unit (GPU), an auxiliary power unit (APU), a storage unit, and a network module.

In some embodiments, when the requirement is to increase computing power of the application, the step of adjusting the one or more operating parameters of the set of operating parameters according to the hint signal and the set of operating parameters further comprising: calculating a ratio of energy consumption for each of the one or more computing components and determining that the one or more operating parameters of the set of operating parameters need to be adjusted to achieve an optimal efficiency point according to the ratio of energy consumption.

In some embodiments, before receiving the hint signal from the application, the method further comprises monitoring operating parameters of computing components in the device; identifying at least one computing component that cause performance bottleneck based on the operating parameters; and calculating power curve for each of the computing components to obtain an operating point that solves the performance bottleneck.

In an exemplary embodiment, a device for adjusting platform capability for optimizing performance is provided. The device comprises one or more processors and one or more computer storage media for storing one or more computer-readable instructions. The processor is configured to drive the computer storage media to execute the following tasks. The computer storage media receives a hint signal from an application, wherein the hint signal indicates a requirement required by the application. The computer storage media obtains a set of operating parameters of one or more computing components related to the application. The computer storage media adjusts one or more operating parameters of the set of operating parameters according to the hint signal and the set of operating parameters to meet the requirement required by the application.

In an exemplary embodiment, a non-transitory computer-readable medium storing instructions is provided. The non-transitory computer-readable medium storing instructions that, when executed by a processor, cause the processor to perform a method for adjusting platform capability for optimizing performance, the method comprises receiving a hint signal from an application, wherein the hint signal indicates a requirement required by the application. The method comprises obtaining a set of operating parameters of one or more computing components related to the application. The method comprises adjusting one or more operating parameters of the set of operating parameters according to the hint signal and the set of operating parameters to meet the requirement required by the application.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a diagram illustrating a computing system for adjusting platform capability for optimizing performance according to an embodiment of the present disclosure.

FIG. 2 is a diagram illustrating the computing system for adjusting platform capability for optimizing performance according to an embodiment of the present disclosure.

FIG. 3 is a flow chart illustrating the method for adjusting platform capability for optimizing performance according to an embodiment of the disclosure.

FIG. 4 illustrates an exemplary operating environment for implementing embodiments of the present disclosure.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

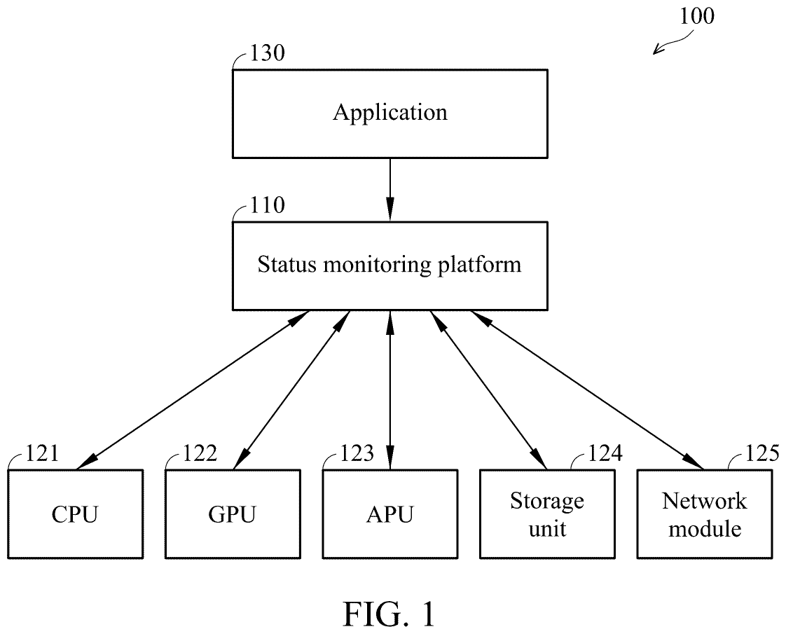

FIG. 1 is a diagram illustrating a computing system for adjusting platform capability for optimizing performance according to an embodiment of the present disclosure. The computing system may be implemented in an electronic device 100, such as a mobile phone, a tablet, a wearable device, etc. However, this is not meant to be a limitation of the present disclosure. That is, any electronic device using the proposed method for adjusting platform capability for optimizing performance falls within the scope of the present disclosure. In this embodiment, the electronic device 100 may have a status monitoring platform 110, and a plurality of physical computing components. The physical computing components may at least include a central processing unit (CPU) 121, a graphics processing unit (GPU) 122, an auxiliary power unit (APU) 123, a storage unit 124, a network module 125. The status monitoring platform 110 is coupled to the computing components 121˜125 and arranged to perform the proposed method for adjusting platform capability for optimizing performance and monitor status information and operating parameters of the computing components 121˜125. For clarity and simplicity, only four computing components 121˜125 are illustrated in FIG. 1. In practice, the electronic device 100 may have more than five computing components, depending upon actual design consideration.

The status monitoring platform 110 can comprise one or more microprocessors and other processing circuitry that retrieves and executes software, such as user interface and operating system, from an associated storage system. The status monitoring platform 110 can be implemented within a single processing device but can also be distributed across multiple processing devices or sub-systems that cooperate in executing program instructions. Examples of the status monitoring platform 110 include general purpose central processing units, application specific processors, and logic devices, as well as any other type of processing device, combinations, or variations thereof.

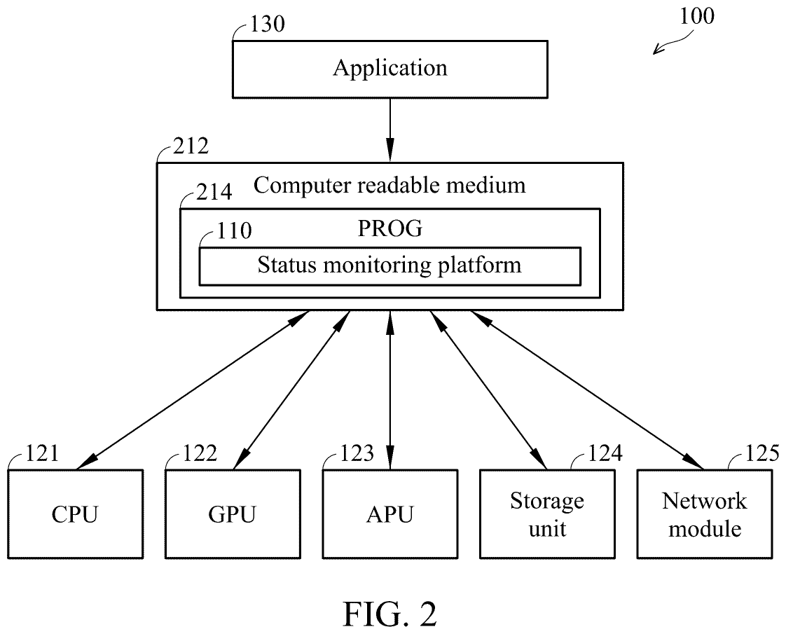

By way of another example, but not limitation, the status monitoring platform 110 may be part of an operating system (OS) supporting a computing environment. Hence, the status monitoring platform 110 may be a software module running on the computing system. As shown in FIG. 2, the electronic device 100 may have a computer readable medium 212 such as a memory device. The computer readable medium 212 may store a program code (PROG) 214. When the program code 214 is loaded and executed by electronic device 100, the status monitoring platform 110 may perform the proposed method for adjusting platform capability for optimizing performance which will be detailed later.

In some embodiments, the status monitoring platform 110 may monitor the computing components 121˜125 and obtain status information of the computing components 121˜125, wherein the status information may include operating parameters, and the operating parameters may comprise one or more of: a workload level, an amount of computation, a power state, amount of network transmission traffic, a frame rate of a display of the electronic device 100, a thermal state, a battery state, a processing capacity state, one or more user settings (e.g., a low-power mode), an application state (e.g., image capture, video record, video preview, image playback, video playback, etc.), a memory usage state, and one or more temperature-related conditions.

The status monitoring platform 110 may receive a hint signal from an application 130, wherein the hint signal indicates a requirement required by the application 130. The status monitoring platform 110 provides an adaptive algorithm to dynamically adjust to the operating parameters of the computing components 121˜125 according to the hint signal and the status information during operation. For example, the application 130 transmits a hint signal to request the status monitoring platform 110 to increase the power of the CPU 121. The status monitoring platform 110 uses the adaptive algorithm to determine that simply boosting the CPU 121 is not enough to effectively increase the power of the CPU 121, and that the computing power of the storage unit 124 and the network module 125 needs to be increased. In other words, the status monitoring platform 110 may determine which computing components need to be adjusted based on the current status and/or the current operating parameters of computing elements related to the application 130, rather than just adjusting the power of the CPU 121.

Furthermore, the status monitoring platform 110 may store level information of all operating parameters of the computing components 121˜125. For example, each operating parameter may be divided into ten levels. The status monitoring platform 110 may analyze status information of the computing components 121˜125 and the hint signal to determine which operating parameters need to be adjusted from the current level to the most appropriate level to achieve an optimal efficiency point.

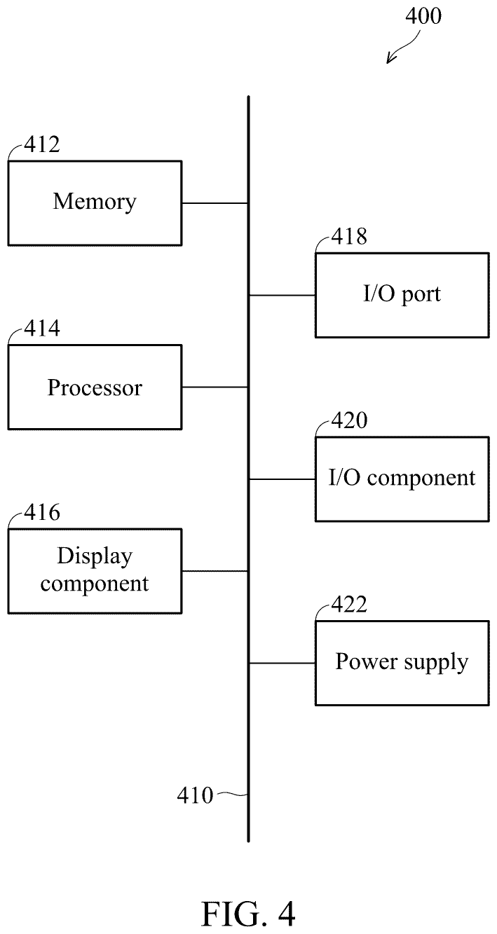

It should be understood that the electronic device 100 shown in FIG. 1 is an example of one suitable system architecture adjusting platform capability for optimizing performance. Each of the components shown in FIG. 1 may be implemented via any type of electronic device, such as the electronic device 400 described with reference to FIG. 4, for example.

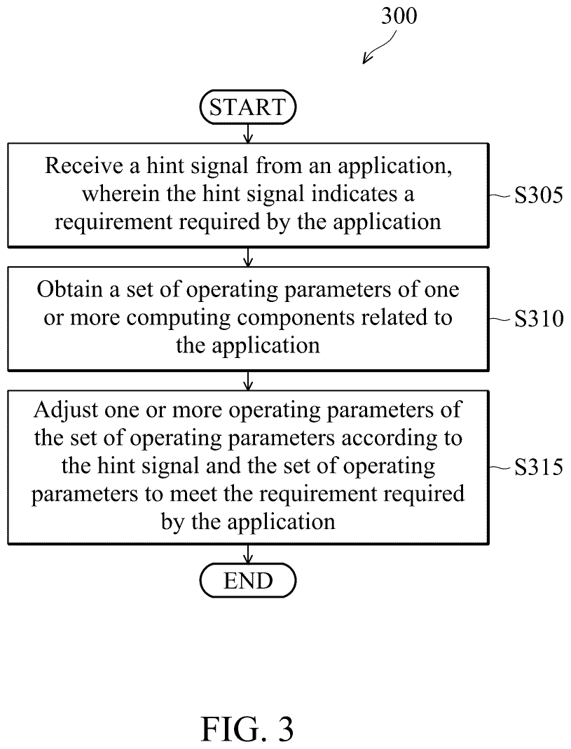

FIG. 3 is a flow chart 300 illustrating the method for adjusting platform capability for optimizing performance according to an embodiment of the disclosure. In this embodiment, the method is implemented by the status monitoring platform 110 of the electronic device 100 in FIG. 1, or a processor 414 of a device 400 in FIG. 4.

In step S305, the processor receives a hint signal from an application, wherein the hint signal indicates a requirement required by the application.

Then, in step S310, the processor obtains a set of operating parameters of one or more computing components related to the application. In some embodiments, the set of operating parameters comprises at least one of the following operating parameters: a workload level, an amount of computation, a power state, amount of network transmission traffic, a frame rate of the display of the device and a thermal state. In some embodiments, the one or more computing components at least comprises a central processing unit (CPU), a graphics processing unit (GPU), an auxiliary power unit (APU), a storage unit, and a network module.

In step S315, the processor adjusts one or more operating parameters of the set of operating parameters according to the hint signal and the set of operating parameters to meet the requirement required by the application. In some embodiments, when the requirement is to increase the computing power of the application, the processor calculates the ratio of energy consumption for each of the one or more computing components. The processor may determine that the one or more operating parameters of the set of operating parameters need to be adjusted to achieve an optimal efficiency point according to the ratio of energy consumption.

In some embodiments, before receiving the hint signal from the application, the processor monitors operating parameters of computing components in the device, identifies at least one computing component that cause performance bottleneck based on the operating parameters, and calculates power curve for each of the computing components to obtain an operating point that solves the performance bottleneck.

As mentioned above, the methods for adjusting platform capability for optimizing performance, devices and computer-readable medium thereof in the disclosure may determine which computing components need to be adjusted based on the current status and/or the current operating parameters of computing elements related to the application, rather than just adjusting operating parameters of a single computing component.

It should be noted that the status monitoring platform 110 in FIG. 1 may be implemented in hardware, software, firmware, or any combination thereof. For example, the status monitoring platform 110 may be implemented as computer program code configured to be executed in one or more processors. Alternatively, the status monitoring platform 110 may be implemented as hardware logic/electrical circuitry.

The embodiments described herein, including systems, methods/processes, and/or apparatuses, may be implemented using well known servers/computers, such as an electronic device 400 shown in FIG. 4. For example, the electronic device 100 can be implemented using one or more electronic devices 400. The electronic device 400 is described as follows, for purposes of illustration.

Referring to FIG. 4, an exemplary operating environment for implementing embodiments of the present disclosure is shown and generally known as an electronic device 400. The electronic device 400 is merely an example of a suitable computing environment and is not intended to limit the scope of use or functionality of the disclosure. Neither should the electronic device 400 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 4, the electronic device 400 may include a bus 410 that is directly or indirectly coupled to the following devices: one or more memories 412, one or more processors 414, one or more display components 416, one or more input/output (I/O) ports 418, one or more input/output components 420, and an illustrative power supply 422. The bus 410 may represent one or more kinds of busses (such as an address bus, data bus, or any combination thereof). Although the various blocks of FIG. 4 are shown with lines for the sake of clarity, and in reality, the boundaries of the various components are not specific. For example, the display component such as a display device may be considered an I/O component and the processor may include a memory.

The electronic device 400 typically includes a variety of computer-readable media. The computer-readable media can be any available media that can be accessed by electronic device 400 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 400. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 412 may include computer-storage media in the form of volatile and/or nonvolatile memory. The memory may be removable, non-removable, or a combination thereof. Exemplary hardware devices include solid-state memory, hard drives, optical-disc drives, etc. The electronic device 400 includes one or more processors that read data from various entities such as the memory 412 or the I/O components 420. The display component(s) 416 present data indications to a user or to another device. Exemplary presentation components include a display device, speaker, printing component, vibrating component, etc.

The I/O ports 418 allow the electronic device 400 to be logically coupled to other devices including the I/O components 420, some of which may be embedded. Illustrative components include a microphone, joystick, game pad, satellite dish, scanner, printer, wireless device, etc. The I/O components 420 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 400, or any combination thereof. The electronic device 400 may be equipped with depth cameras, such as stereoscopic camera systems, infrared camera systems, RGB camera systems, or any combination thereof, to realize gesture detection and recognition. Furthermore, the electronic device 400 may be equipped with accelerometers or gyroscopes that enable detection of motion. The output of the accelerometers or gyroscopes may be provided to the display of the electronic device 400 to carry out immersive augmented reality or virtual reality.

Furthermore, the processor 414 in the electronic device 400 can execute the program code in the memory 412 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for adjusting platform capability for optimizing performance, implemented by a processor of a device, comprising:
receiving a hint signal from an application, wherein the hint signal indicates a requirement required by the application;
obtaining a set of operating parameters of one or more computing components related to the application; and
adjusting one or more operating parameters of the set of operating parameters according to the hint signal and the set of operating parameters to meet the requirement required by the application.

2. The method for adjusting platform capability for optimizing performance as claimed in claim 1, wherein the set of operating parameters comprises at least one of the following: a workload level, an amount of computation, a power state, amount of network transmission traffic, a frame rate of a display of the device and a thermal state.

3. The method for adjusting platform capability for optimizing performance as claimed in claim 1, wherein the one or more computing components at least comprises a central processing unit (CPU), a graphics processing unit (GPU), an auxiliary power unit (APU), a storage unit, and a network module.

4. The method for adjusting platform capability for optimizing performance as claimed in claim 1, wherein when the requirement is to increase computing power of the application, the step of adjusting the one or more operating parameters of the set of operating parameters according to the hint signal and the set of operating parameters further comprises:
calculating a ratio of energy consumption for each of the one or more computing components; and
determining that the one or more operating parameters of the set of operating parameters need to be adjusted to achieve an optimal efficiency point according to the ratio of energy consumption.

5. The method for adjusting platform capability for optimizing performance as claimed in claim 1, wherein before receiving the hint signal from the application, the method further comprises:
monitoring operating parameters of computing components in the device;
identifying at least one computing component that cause performance bottleneck based on the operating parameters; and
calculating power curve for each of the computing components to obtain an operating point that solves the performance bottleneck.

6. A device for adjusting platform capability for optimizing performance, comprising:
one or more processors; and
one or more computer storage media for storing one or more computer-readable instructions, wherein the processor is configured to drive the one or more computer storage media to execute the following tasks:
receiving a hint signal from an application, wherein the hint signal indicates a requirement required by the application;
obtaining a set of operating parameters of one or more computing components related to the application; and
adjusting one or more operating parameters of the set of operating parameters according to the hint signal and the set of operating parameters to meet the requirement required by the application.

7. The device for adjusting platform capability for optimizing performance as claimed in claim 6, wherein the set of operating parameters comprises at least one of the following: a workload level, an amount of computation, a power state, an amount of network transmission traffic, a frame rate of display of the device and a thermal state.

8. The device for adjusting platform capability for optimizing performance as claimed in claim 6, wherein the one or more computing components at least comprises a central processing unit (CPU), a graphics processing unit (GPU), an auxiliary power unit (APU), a storage unit, and a network module.

9. The device for adjusting platform capability for optimizing performance as claimed in claim 6, wherein when the requirement is to increase computing power of the application, the step of adjusting the one or more operating parameters of the set of operating parameters according to the hint signal and the set of operating parameters further comprises:
calculating a ratio of energy consumption for each of the one or more computing components; and
determining that the one or more operating parameters of the set of operating parameters need to be adjusted to achieve an optimal efficiency point according to the ratio of energy consumption.

10. The device for adjusting platform capability for optimizing performance as claimed in claim 6, wherein before receiving the hint signal from the application, the processor further executes the following tasks:
monitoring operating parameters of computing components in the device;
identifying at least one computing component that cause performance bottleneck based on the operating parameters; and
calculating power curve for each of the computing components to obtain an operating point that solves the performance bottleneck.

11. A non-transitory computer-readable medium storing instructions that, when executed by a processor, cause the processor to perform a method for adjusting platform capability for optimizing performance, the method comprising:
receiving a hint signal from an application, wherein the hint signal indicates a requirement required by the application;
obtaining a set of operating parameters of one or more computing components related to the application; and
adjusting one or more operating parameters of the set of operating parameters according to the hint signal and the set of operating parameters to meet the requirement required by the application.

12. The non-transitory computer readable medium as claimed in claim 11, wherein the set of operating parameters comprises at least one of the following: a workload level, an amount of computation, a power state, an amount of network transmission traffic, a frame rate of a display of the device and a thermal state.

13. The non-transitory computer readable medium as claimed in claim 11, wherein the one or more computing components at least comprises a central processing unit (CPU), a graphics processing unit (GPU), an auxiliary power unit (APU), a storage unit, and a network module.

14. The non-transitory computer readable medium as claimed in claim 11, wherein when the requirement is to increase computing power of the application, the step of adjusting the one or more operating parameters of the set of operating parameters according to the hint signal and the set of operating parameters further comprises:
calculating a ratio of energy consumption for each of the one or more computing components; and
determining that the one or more operating parameters of the set of operating parameters need to be adjusted to achieve an optimal efficiency point according to the ratio of energy consumption.

15. The non-transitory computer readable medium as claimed in claim 11, wherein before receiving the hint signal from the application, the method further comprises:
monitoring operating parameters of all computing components in the device;
identifying at least one computing component that cause performance bottleneck; and
calculating power curve for each of the computing components to obtain an operating point that achieves better efficiency.
